(19) United States
(12) Patent Application Publication
(10) Pub. No.: US 2026/0169459 A1
(43) Pub. Date: Jun. 18, 2026

(54) METHOD FOR AN ADDITIVE MANUFACTURING DEVICE

(71) Applicant: Tyler KETCHUM, Littleton, CO (US)

(72) Inventor: Tyler KETCHUM, Littleton, CO (US)

(21) Appl. No.: 19/421,130

(22) Filed: Dec. 16, 2025

Related U.S. Application Data
(60) Provisional application No. 63/734,386, filed on Dec. 16, 2024.

(51) Int. Cl. G05B 19/4099; B29C 64/386; B29C 64/40; B33Y 50/00

(52) U.S. Cl. CPC G05B 19/4099; B29C 64/386; B29C 64/40; B33Y 50/00; G05B 2219/35134; G05B 2219/49023

(57) ABSTRACT

The present disclosure provides a method that receives the 3D geometry(s) of object(s) which are to be manufactured by an additive manufacturing (AM) device. A general statistical model is applied to predict the geometric inaccuracies of the resulting manufactured object(s). This model can account for the shape and orientation of the object(s), as well as the specific device configuration, process parameters, feedstock characteristics, etc., with which the object(s) are to be manufactured. The method yields a compensated 3D geometry, which includes compensation for predicted geometric deviations. AM instruction set(s) based on this compensated geometry can cause an AM device to manufacture object(s) that match the intended geometry. Additionally, the method can produce support structure placement plans (based on data including the predicted deviations) that apply supports where necessary to preempt sever deviations and process failures.

### RELATED APPLICATIONS

This application claims priority to U.S. Provisional Application No. 63/734,386, filed Dec. 16, 2024 and titled “A Method for a Slicer Application of an Additive Manufacturing Device.” The contents of this priority application are incorporated by reference herein in their entirety.

### BACKGROUND

A 3D printer is a device which permits the fabrication of objects by the sequential addition of layers of material. The workflow to use such an additive manufacturing (AM) device to print an object typically involves the use of a “slicer engine” to prepare an instruction set which the device executes to fabricate the object.

Certain geometries, such as overhangs and “bridges” are challenging for some types of additive manufacturing (AM) devices to produce, requiring the device to deposit material beyond, or with a varying degree of overlap with, the horizontal extent of the previous layer. Attempting to print such geometries frequently results in unacceptably poor object surface quality, significantly reduced dimensional accuracy, and in some cases local or global process failure. To enable printing of geometries such as overhangs and bridges, the user of an AM device can designate areas on the surface of the object to be supported with “supports” while configuring (such as in a slicer) the print. Alternatively, AM workflows typically permit the automatic addition of supports to surfaces of the object for which the angle between the print bed normal (i.e., the direction in which the object grows as layers are added) and the surface normal (i.e., the vector which extends perpendicularly outwards from the surface) exceed a certain threshold. Such support structures are removable, scaffolding-like structures printed by the device itself, often in the same material in which the object is to be manufactured. Supports, however, increase the printing time of the object, waste material, add post-processing steps, are in some cases difficult or impossible to completely remove, and frequently degrade the surface quality of the surfaces they support. Nevertheless, support structures are often placed in areas where they are not needed, frequently wasting time and material, and, conversely, are sometimes not placed where they are needed, frequently resulting in unacceptable deviations, or even local or total process failures.

Additionally, many objects manufactured by many types of AM processes suffer from multiple shape deviation patterns. For example, in an AM process known as Fused Filament Fabrication (FFF), material is melted, extruded through a moving nozzle, and cooled. As the material cools, it shrinks, often warping the print. Moreover, material frequently oozes during deposition, the nozzle often fails to accurately trace its intended path, and the width of the nozzle itself often introduces other geometric inaccuracies. In another type of AM process known as Stereolithography (SLA), layers are formed by curing a resin in certain areas with a light source. The resin shrinks as it cures, introducing geometric inaccuracies. Deviation patterns such as those discussed above present a challenge to users of AM technologies and may render the manufacturing of low tolerance geometry with AM technology difficult or impossible. AM workflows frequently involve iterative refinements of input geometry to produce acceptable output geometry, necessitating expensive and time-consuming test prints.

These and other deficiencies exist.

### SUMMARY

It is an object of the present disclosure to provide an exemplary method, device, computer medium-accessible, and system by which the optimum placement and extent of support structures may be automatically calculated. It is another object of this disclosure to provide a method, device, computer-accessible medium, and system by which geometric deviations may be minimized. Thus, it may be beneficial to provide exemplary systems, methods and computer-accessible medium that can overcome at least some of the deficiencies described herein above.

Accordingly, the present disclosure addresses the above identified problems, as well as other problems with printing 3D objects, by providing an exemplary implementation of an exemplary method which can receive one or more digital file(s) containing the 3D geometry(s) of object(s) which are to be manufactured by an additive manufacturing (AM) device. In an exemplary method, device, computer-accessible medium, and system according to an exemplary embodiment of the present disclosure, when the user instructs the computer, e.g., presses a button, for each object, a machine learning (ML) algorithm (which has been pre-trained, e.g., on data from historical prints) can predict the geometric inaccuracies of the physical object as it will be printed. In an example embodiment, the ML algorithm can account for the shape and orientation of the object, and the specific process settings with which it will be manufactured. In an example embodiment, the method can use these predictions to calculate the optimum placement and extent of support structures and/or offset the surface of the 3D object to be manufactured to compensate for the predicted deviations. It is an object of this disclosure to provide an exemplary method, device, computer-accessible medium, and system by which a trained ML algorithm can be used to predict AM deviations, and by which those deviations can be minimized.

In many embodiments, the method is stand alone. In some other embodiments, the method is presented in the context of a slicer application, which may, for example, permit the generation of an AM instruction set based on the geometric and/or support placement optimizations calculated by the method. In some such example embodiments, the slicer software can be installed on a user's computer system. In some embodiments, when the slicer software is accessed, e.g., on the computer system, a graphical interface depicting the printer's build volume and containing, among other things (e.g., a video feed which may, for example, allow the user to remotely monitor an AM device, or settings panels which may permit, for example, the selection of the projection mode in which entities such as the build volume and the objects to be sliced are displayed. Examples of projection modes include orthogonal, perspective, X-ray, etc.), a “slice button” is displayed. The interface can also allow the user to set parameters pertaining to the AM process (or even slicer behavior), e.g., the layer height, nozzle acceleration, instruction set output format, etc. The user can select one or more virtual files that may be stored in the computer's memory and contain 3D geometry. Such files may even be downloaded to the computer, for example via the internet. By selecting such file(s), 3D object(s) can be loaded (for embodiments involving a slicer, i.e. into the slicer's graphical user interface), which can allow the user to manipulate the object(s). Such manipulations may include rotations, translations, transformations, and even geometry operations such as the splitting of an object into two parts or the joining of two objects such that they are printed as one. In one example, at any point the user may select another 3D geometry file to be loaded. In one example, multiple objects may be printed simultaneously with the same AM device. Once the user has arranged the object(s), they may send an instruction to the computer, e.g., by a command prompt, the clicking of a button (such as, in some implementations, for example those including a slicer, the “slice button”), a specific combination of keystrokes, etc.

In some examples, upon receiving an instruction, a sequence of calculations can occur that can result in 3D geometry which includes compensation for AM deviations and/or calculations of the optimal placement and extent of support structures. In some embodiments (such as, in some examples, those that include a “slicer engine”), a sequence of further calculations can occur that can result in the preparation of an AM instruction set based on the compensated geometry. In one embodiment, the calculations could include a feature extraction step that can involve the calculation of descriptions (for example, numerical descriptions) of the 3D geometry, an application of the extracted features to a general statistical model (such as a machine learning model) that can predict geometric deviations, and/or a compensation step in which the 3D geometry can be modified (and/or a support placement plan in which supports are placed only and exactly where necessary could be determined) based on the generated predictions so as to minimize the as-printed deviations in the final object and/or provide optimal support placement and extent. In some embodiments (such as, for example, some embodiments which involve a slicer), further calculations could result in the production of an instruction set to be used by an AM device based on the compensated 3D geometry and/or calculated support structure placement. Such instruction sets may include compensation for AM deviations, and/or, in some exemplary embodiments, the manufacturing of support structures. In some examples, the instruction set can include other objects, e.g., skirts, draft shields, rafts, brims, etc. Once these calculations have been performed for some (e.g., all, or those selected, e.g. by the user) of the object(s), in some embodiments (such as, for example, some embodiments which involve a slicer), an instruction set can be generated (e.g. by a component of a slicer software, i.e. a “slicer engine”) which may be used by the AM device to print the (compensated) object(s), potentially with (optimally placed) support structure(s). When executed by the AM device, the instruction set can cause the AM device to manufacture the 3D object(s) with a greater accuracy, and, if applicable, to manufacture support structures whose placement and extent is optimized.

In another example embodiment, software is installed on a computer system. When the software (which in some embodiments could include a slicer application) is accessed, means which could allow the user to (for example) select 3D object file(s) to be printed may arise. Examples of such means include interfaces (i.e. graphical, textual, etc.), windows, dialogs, etc. These means may even permit the user to manipulate, arrange, etc, the object(s). In one embodiment, when the user instructs the computer system, e.g., by pressing a button, some or all the calculations mentioned above (such as the feature extraction step) that permit the geometric and/or support placement optimization of the 3D objects can be performed remotely from the user's computer by a server computer. In some embodiments, further calculations (which may be based on the results of the prior calculations) that permit the preparation of a geometrically compensated and/or optimally supported instruction may occur. These further calculations can be performed by a computer (for example, the user's computer, or even remotely, such as by a server computer). In some embodiments, the user's computer may contain a transceiver module which could allow it to transmit and receive data to and from one or more separate computers, which may also contain transceiver modules. When the user instructs the computer system, some calculation steps (such as feature extraction) may be performed by the user's computer. The user's computer could then employ its transceiver module to transmit (potentially over third-party communication infrastructure such as a cellular tower or other transmission/receiving infrastructure) relevant data (e.g., the features, process parameters, object placement and/or orientation, etc.) to a server, which can use the data to perform one or more of the calculation steps. In some embodiments, the server can use its transceiver module to send a calculation set (which could be the partially or fully completed results of one or more calculation steps, or even geometrically compensated object(s) and/or determinations of optimal support placement. In some embodiments, such as some embodiments which include a slicer, the calculation set could even be an AM instruction set, which could include geometric optimizations and/or optimally placed support structures.) to the user's computer. In some cases, the user's computer may need to finish the calculation sequence, which could involve completing the computational steps required to produce geometrically optimized 3D objects and/or determine optimal support placement. In some embodiments, finishing the calculation sequence could even involve “slicing” (for example, using a “slicer engine”) the 3D objects (for example, the geometrically optimized 3D objects) so as to, for example, produce an AM instruction set which could include instructions that cause the AM device to manufacture (for example, with increased accuracy) the 3D objects, and could even include instructions that could cause the AM device to manufacture (for example, concurrently with the objects) optimally placed support structures.

In another example embodiment, the software can run entirely on one or more server computers. A user's computer may interface with the server via its transceiver module (e.g., over third-party communication infrastructure such as a fiber-optic cable). In one example, when the user opens the software (e.g., in an internet browser such as, for example, Opera or Bing), they may upload 3D geometry file(s). In some embodiments, they may manipulate virtual representations of 3D object(s), such as in an interface. In some embodiments, the user may set (e.g., for all objects or on an object-by-object basis) process parameters such as layer height, maximum nozzle speed, etc., and when satisfied with the print configuration, may initiate (for example, by pressing a button) a sequence of computational steps. In one embodiment, all the computational steps may be completed on the server, which could transmit a finished calculation set (In some embodiments, finished calculations sets may be geometrically compensated object(s) and/or support placement plans. In some embodiments, such as some embodiments which include a slicer engine, the calculation set could even be an AM instruction set, which could include elements such as instructions that can cause an AM device to manufacture geometrically optimized objects and/or instructions to manufacture optimally placed support structures.) to the user's computer. In another embodiment, some steps are performed on the user's computer and other steps are performed on the server.

In some embodiments, the computational load of a single computational step may be divided between one or more server computers, and potentially the user's computer. In yet another embodiment, the server can serve as a means to provide a user interface, but all computational steps can be performed on the user's computer. In some embodiments, parameters regarding the involvement of server computer(s) may be specified (by, for example, the user, software configuration files, etc. The parameters could even be specified by software configuration rules, which could cause different parameters to be applied based on factors such as internet connectivity status, data associated with the user, 3D object facet count, server availability, etc.). Examples of parameters regarding the involvement of server computer(s) could include the number of servers to be utilized, the computational step(s) (or portions thereof) which are to be performed by the server(s), the priority of the computations relative to that of other tasks to be performed by the server, etc.

In some embodiments, the user can select the nature of the output, which may include one or more of, for example, geometrically optimized 3D object(s), determinations of optimal support structure placement, and (such as in some embodiments which include slicing capability) completed AM instruction set(s).

In some embodiments, a single user action (such as “dragging and dropping” a virtual file, executing a command, clicking an icon, etc.) can cause the software to produce a completed calculation set (which may, for example, include geometrically optimized 3D objects, determinations of optimal support placements, etc., or even finished AM instruction sets). In some embodiments, the user could invoke the software and specify data (which could include process parameters, 3D geometry, server configuration parameters, etc.) with the same action (such as, in one example, executing a command, such as in a terminal). In some (i.e. the same, or other) embodiments, the user may be able to invoke the software and specify virtual files which contain data such as process parameters, 3D geometry, server configuration parameters etc., with as few as one action. In some implementations, the user may be able to invoke the software and specify some data directly (for example, textually) and some data indirectly (for example, by specifying a virtual file which contains the data). In some embodiments, the user could specify the data (or portions thereof) directly or indirectly at their discretion, for example, when invoking the software. In some embodiments, the data can include an indication of the nature of the output, which can permit the user to cause the software to yield one or more of, for example, geometrically optimized 3D object(s), support structure placement plans, and (such as in some embodiments which include slicing capability) completed AM instruction set(s), etc.

An exemplary embodiment includes a method, performed by a computer system having one or more processors and a memory system including computer memory containing non-transitory instructions, for providing deviation prediction, compensation, and support placement optimization for additive manufacturing (AM) processes, including: receiving 3D geometry of one or more shapes to be printed; selecting a plurality of points on a surface of the 3D geometry; calculating numerical descriptions of the 3D geometry surrounding each of the plurality of points; predicting a deviation at each of the plurality of points by comparing the calculated numerical descriptions with numerical descriptions associated with measured deviations in historical prints; and at least one of: compensating for deviation by offsetting the geometries such that an as-printed shape will match the received 3D geometry; or selecting regions to be supported based on the predicted deviation, normal vectors of the surfaces for which the deviation was predicted, and dimensions of the regions so selected, wherein offsetting the geometries consists of applying an equivalent amount of offset based on the predicted deviation.

A second exemplary embodiment includes a system, for providing deviation prediction, compensation, and support placement optimization for additive manufacturing (AM) processes, including: one or more computer servers having one or more processors; non-transitory computer memory including instructions, that, when executed by the one or more processors, cause the one or more processors to: receive 3D geometry of one or more shapes to be printed; select a plurality of points on a surface of the 3D geometry; calculate numerical descriptions of the 3D geometry surrounding each of the plurality of points; predict a deviation at each of the plurality of points by comparing the calculated numerical descriptions with numerical descriptions associated with measured deviations in historical prints; and at least one of: compensate for deviation by offsetting the geometries such that an as-printed shape will match the received 3D geometry; or select regions to be supported based on the predicted deviation, normal vectors of the surfaces for which the deviation was predicted, and dimensions of the regions so selected, wherein offsetting the geometries consists of applying an equivalent amount of offset based on the predicted deviation.

A third exemplary embodiment includes a non-transitory computer-readable medium that includes a non-transitory computer-readable medium comprising instructions for execution by one or more processors, wherein, upon execution of the instructions, the one or more processors are configured to perform procedures including: receiving 3D geometry of one or more shapes to be printed; selecting a plurality of points on a surface of the 3D geometry; calculating numerical descriptions of the 3D geometry surrounding each of the plurality of points; predicting a deviation at each of the plurality of points by comparing the calculated numerical descriptions with numerical descriptions associated with measured deviations in historical prints; and at least one of: compensating for deviation by offsetting the geometries such that an as-printed shape will match the received 3D geometry; or selecting regions to be supported based on the predicted deviation, normal vectors of the surfaces for which the deviation was predicted, and dimensions of the regions so selected, wherein offsetting the geometries consists of applying an equivalent amount of offset based on the predicted deviation.

These and other objects, features and advantages of the exemplary embodiments of the present disclosure will become apparent upon reading the following detailed description of the exemplary embodiments of the present disclosure, when taken in conjunction with the accompanying claims.

### BRIEF DESCRIPTIONS OF THE DRAWINGS

FIG. 1 shows a flow chart of the computational steps of a method which can produce geometrically compensated 3D objects and/or optimized support placement plans according to exemplary embodiments.

FIG. 2 shows a flow chart of the computational steps of a method which can produce geometrically compensated 3D objects and/or optimum support placement plans, that can become the input to a slicing step that can produce compensated and/or optimally supported AM instruction sets according to exemplary embodiments.

FIG. 3 shows an embodiment of a computer system, an AM device, and one or more servers according to an example embodiment, as well as some hardware components which can constitute a device (a “data rig”), or a part thereof, by which a general statistical model, fitted to data based on AM processes, may be obtained according to exemplary embodiments.

FIG. 4 shows a schematic of an embodiment in which a digital entity can invoke a computational method, as well as physical memory hardware according to exemplary embodiments.

FIG. 5 shows a schematic of an embodiment which exists in the context of a slicer application, as well as physical memory hardware according to exemplary embodiments.

FIG. 6 shows an example of an object manufactured by an AM device upon which data to which a general statistical model may be fitted may be based upon according to exemplary embodiments.

FIG. 7 shows a demonstrative visualization of a set of features that may be extracted from 3D geometry which may be printed and includes multiple points that lie on the surface of 3D geometry that are shaded according to the values of the features according to exemplary embodiments.

FIG. 8 shows an example of a collection of points that lie on the surface of 3D geometry which may be printed and that have been shaded according to the magnitude and sign of a deviation which may be predicted according to exemplary embodiments.

FIG. 9 shows a schematic of a method to produce datasets to which general statistical models may be fitted according to exemplary embodiments.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION

### The Optimization Pipeline (i.e., the Sequence of Calculations)

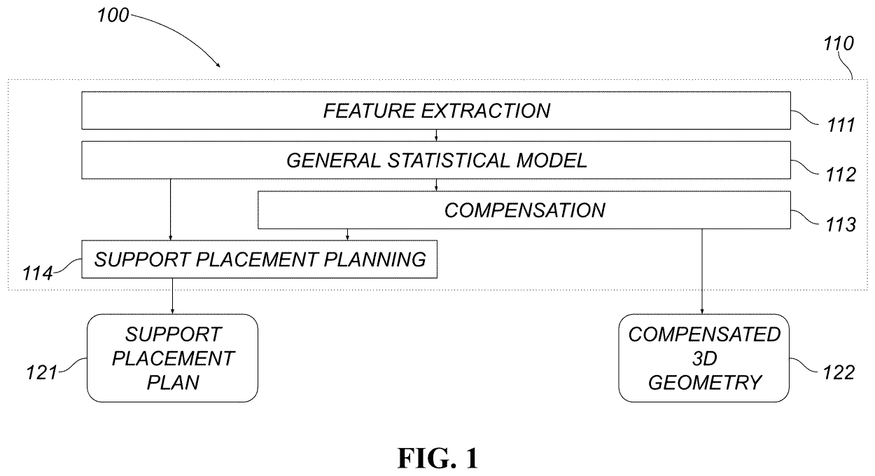

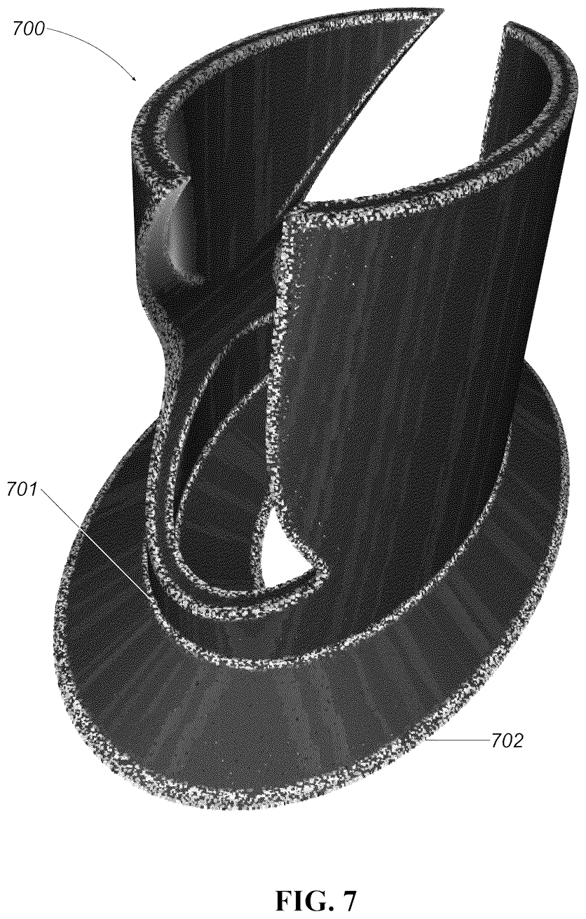

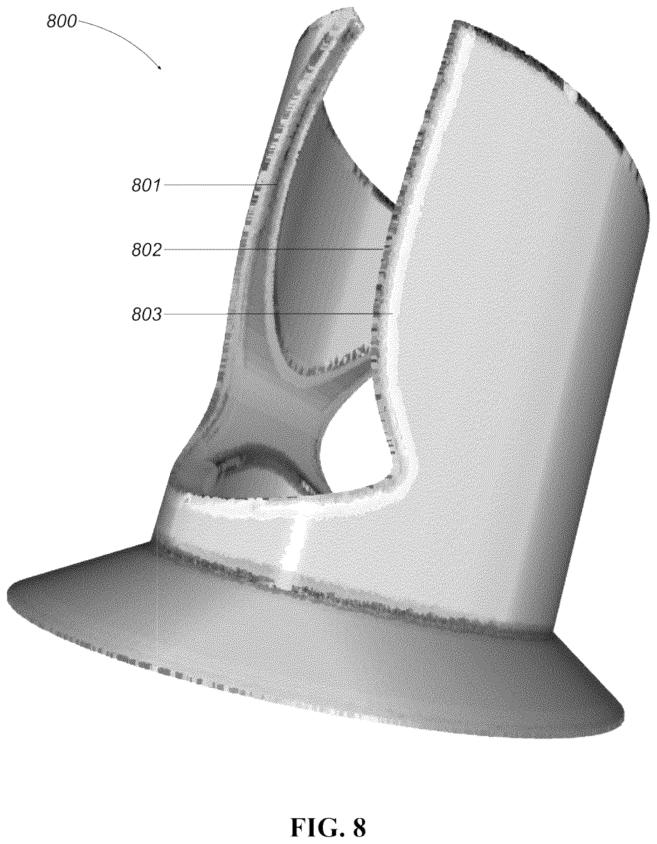

FIG. 1 shows a flow chart 100 of an example configuration of computational steps 110 which can result in optimal support placement plans 121 and 3D geometry which can include compensations for AM deviations 122. In an example embodiment, the computational steps 110 can be performed for each 3D object (such as those that have been specified, i.e., by a user, for example one at a time or concurrently. Initiated (for example) by some indication of (e.g. a user's) instruction, in one example, the computational steps may include a feature extraction step 111 which may involve the calculation of descriptions (such as, for example, numerical descriptions) of, for example, the local geometry surrounding multiple points on the surface of the object (such as those shown in FIG. 7). In one example, the computational steps may include an application of the extracted features to a general statistical model 112. The model could have been fitted to a data set (for example, of AM deviation data based on historical prints) such that, when the code of which the model consists is executed in a particular programing language (such as, for example, R, Python, C++, etc.) with respect to the features from block 111, the model may be used to predict (for example, at multiple points on the object, such as those shown in FIG. 8) the deviations which would be exhibited by the object were it to be manufactured by an AM device. In one example, the computational steps 110 may include a compensation step 113 in which an equivalent amount of offset (i.e., the model wall is offset an equal amount in the opposite direction as the predicted deviation) can be applied. The output 122 of the compensation step 113, then, can represent a 3D object which contains compensation for the geometric deviations patterns intrinsic to an AM device, which, when applied to the downstream AM workflow, can result in a physical object manufactured by the device that more accurately matches the intended 3D object than if the intended 3D object itself were to be applied to the downstream AM workflow. The computational steps 110 may also include a support placement planning step 114, wherein certain regions of the 3D object can be marked to be supported by support structures (as informed, for example, by data that could include the deviations predicted by the general statical model 112, the angle that the normal of the surface on which a deviation was predicted makes with the bed normal, etc.). The output 121 of the support placement planning step 114, then, can include data which could include descriptions of the locations on the 3D object which should be supported by support structures.

In one example embodiment, the computational steps 110 include a feature extraction step 111. The feature extraction calculations may be performed at multiple (e.g., 10, 10,000, 1,000,000 or more) points on the surface of the object (such as those shown in FIG. 7). These points could be placed, for example, randomly, or quasi-uniformly (e.g., via Poisson-disc sampling), or by other means (e.g., at the intersections of the surface of the object with a voxel grid). In some embodiments, the point placement scheme could even involve structures (e.g., “trains” of points which could, for example, be placed along the intersection of the surface of the object with a plane). In some embodiments, the point placement scheme could even be informed by the process geometry (e.g., a “train” of points could be, for example, placed along the loop of line segments formed by the intersection of the 3D geometry and the plane which will be coplanar with a layer of extruded material in the finished object). In some embodiments, geometry of the object could be described by a mesh (such as, for example, a polygonal mesh), and the points could have some relationship with the vertices of that mesh. Examples of such a relationship include an exact correspondence, a correspondence with the vertices of a re-meshed (e.g., isotopically, adaptively, etc.) version of the original object, a correspondence with the centroids of the facets of the mesh, etc. In some embodiments, the point placement scheme could include one or more of the above example elements, and/or other elements not listed.

In some embodiments, the density (which could be global or even local, such as within a voxel, of a point's neighbors, on a facit (such as a planer facit) of a 3D object, etc.) of the point placement scheme can be informed by properties (such as global or local proprieties) of the 3D object. In some embodiments, one such property could be a measure of the intricacy of the 3D geometry, such as could be implied by the density of geometric elements which could constitute the 3D geometry (examples of such elements could include facets, vertices, etc. Their density could be inferred by, for example, a calculation of metrics such as the average area of facets, the number of facets which lie (such as in part or in whole) within (for example) a sphere that intersects or encompasses 3D geometry, the number of vertices which lie within a certain volume, etc.), the curvature (such as gaussian, mean, etc.) of the 3D geometry, the normal vector of surfaces on the 3D geometry, etc. In some embodiments, the density (such as a local or global density) of the point placement scheme could be assessed for example, by a calculation of the number of points in a voxel, the average distance between a point and some number n of its nearest neighbors, the average distance between a point and the nearest neighbor which exists, for example, in each of the bounding boxes which are aligned to a coordinate system and for which one vertex is coincident with the point and another other is the point whose coordinates are a permutation of positive and negative infinity, etc. In some embodiments, the feature extraction step 111 can generate numerical descriptions of the geometry which surrounds each point. In one example, these descriptions can include the angle that the normal vector of the surface on which the point lies makes with the normal vector of the print bed. In one example, the descriptions can also include elements such as, but not limited to, Fast Point Feature Histograms (FPFH) and Signature of Histograms of Orientations (SHOT) descriptors.

In one example embodiment, the general statistical model 112 is an ML algorithm. Types of ML algorithms include decision trees, support vector regressors, random forests, naïve Bayes, neural networks, etc. The model 112 can be fitted to data based on historical prints. These data can include geometric features, such as those extracted in the feature extraction step 111, as well as measurements of the actual deviation (for example, along the normal vector of the surface on which the point lies) between the nominal 3D geometry and the physical printed 3D geometry. These measurements can occur at points on the surface of the 3D geometry, such as the points at which the features were extracted 111. By fitting the general statistical model 112 to the training data, in one example, the model 112 can be applied to data (such as, for example, extracted features) based on never before printed objects (or objects which have never been printed with the configuration of software, hardware, process parameters, etc. used to prepare the objects upon which the training dataset was based) and thus make predictions of the deviation measurements which would be observed were such objects to be printed. In one embodiment, the fitted general statistical model 112 is included in the code for the software and receives features from the feature extraction step 111 based on the 3D object(s) for which geometric compensation and/or support placement planning is to occur. In some embodiments, at each point at which features were extracted the model can predict the deviation (for example, along the normal vector of the surface on which the point lies) from the intended geometry which will be exhibited by the physical, manufactured geometry, such as is illustrated in FIG. 8.

Different AM devices (i.e., devices made by different manufacturers, or different models of devices produced by the same manufacturer) may exhibit different deviation patterns. The same AM device can also exhibit different deviation patterns based on its configuration, including that of its hardware, software, material with which it is printing, and process parameters. Such devices frequently operate in different configurations (including hardware, such as, for example, nozzle type, and software, such as, for example, input shaping). AM devices can frequently print with different materials (e.g., polylactic acid (PLA), acrylonitrile butadiene styrene (ABS), polyethylene terephthalate glycol (PETG), as well as similar materials and combinations thereof). Further, the properties of the same type of material (i.e., PLA) may differ sufficiently between manufacturers to induce different deviation patterns. AM devices can also operate under a wide variety of process parameters (i.e., layer height, part infill density, nozzle temperature, part wall thickness, nozzle acceleration, cooling fan power etc.) which may lead to the same device exhibiting different deviation patterns between prints of different process parameters, even when printing with the same material, of the same manufacturer, in the same device configuration. Therefore, some embodiments may feature multiple ML algorithms, each fitted to data based on a specific permutation of print configurations (which may include, e.g., elements such as those listed above).

Some embodiments could even feature multiple ML algorithms of different types (i.e., Decision Tree, Support Vector Regressor, Neural Network, etc.) fitted to, for example, datasets based on the same permutation of print configurations. Thus, for example, an ML algorithm of a type suited to the available hardware (i.e., a Graphics Processing Unit) of the user's computer could be selected (for example automatically, by the user, etc.).

Some embodiments may feature a mechanism (i.e., a user interface element, command flag, option, etc.) to permit the user to select an appropriate ML algorithm based on the configuration of the AM device for which instruction sets are to be prepared and/or the configuration of the user's computer. Some embodiments may feature (in leu of, or even in addition to a user interface element) a mechanism by which an appropriate algorithm may be automatically selected. Some embodiments feature, for example, a user interface element which could facilitate the selection of settings pertaining to the configuration of the sequence of calculations. Examples of such settings could include the point placement scheme (such as those described in paragraph [0030]), the density of point placement, the type (i.e., Decision Tree, Support Vector Regressor, Neural Network, etc.) of the algorithm to be used, the number of features to be calculated for each point, etc. By manipulating such settings, the user could, for example, facilitate a balance between the accuracy of the optimization and processing time required to complete it.

Some embodiments could feature a mechanism, such as a user interface element, to permit the user to select, for example, the type of optimizations which are to occur. Such settings could, for example, permit the user to specify whether the object geometry and/or support placement is to be optimized. In some embodiments, the user could even configure the application of the optimizations by manipulating settings which could include, for example, the maximum distance which the object geometry may be offset, the minimum area (e.g., of the object, support cross section, etc.) required for a region to be supported, the minimum thickness of a supported region, etc. Such settings could be applied, for example, to all objects, on an object-by-object bases, or even to specific regions on an object.

Data which may be germane to AM processes (and potentially serve as inputs to, and describe the desired type and nature of outputs of, a sequence of computational steps such as those in block 110, in a slicer engine 241, etc.) can include dimensional data (such as, for example, the desired 3D geometry to be manufactured, the positions and orientations in which they will be manufactured inside of the AM device, etc.), as well as that which may pertain to, among other things, process geometry (such as, for example, layer height, infill density, wall thickness, etc.), process parameters (such as, for example, material deposition rates, printhead temperature, exposure time, cooling fan power settings, etc.), the AM device to be used in the process (such as its configuration, build volume dimensions, warm up times, belt tightness, etc.), device firmware (such as, for example, input shaping, linear/pressure advance/K values, etc.), the process feedstock (such as, for example, its type, manufacturer, specific cost, color, age, pellet size, filament diameter, etc.), slicer engine configuration (such as, for example, seam positioning, ooze management strategies, instruction set “flavor”, start and end codes, etc.), and in some embodiments (e.g. those that feature server computers 331) server computer configuration (such as, for example, the number and type of server computers to be used, the computational steps which are to be perfumed by servers, etc.), etc.

In some example embodiments, data such as that enumerated in paragraph [0038] could be used in the training of the general statistical model 112, which could, for example, result in a model that is tailored to make deviation predictions for, for example, a specific AM device, permutation of process parameters, process geometry, slicer configuration, process feedstock, etc. In some embodiments, the software includes multiple general statistical models that are fitted to different training datasets based on different permutations of the above.

In some example embodiments, data from the atmospheric sensor suite 361 can be used in the training of the general statistical model 112, which could, for example, result in a model that is tailored to the environmental conditions in which, for example, the feedstock is stored, the print occurs, etc. Such data may include measurements of temperature, humidity, dew point, air movement, etc. In some embodiments, the data could be recorded at intervals such as, for example, every hour, minute, or second.

In one example embodiment, a compensation step 113 uses the deviations predicted by the algorithm 112 to digitally modify the geometry of the 3D object. In one example, for each point on the surface of the object for which a deviation was predicted pₒ, the surface of the object can be offset such that the point p_{c}, found by offsetting pₒ (for example, along the normal vector of the surface upon which pₒ lies) a distance equal but opposite to the predicted deviation at pₒ, lies upon the surface of the object to be sliced. In some embodiments, the entire set of points p_{c} can generated, and a reconstruction algorithm (e.g., Rolling Ball, Advancing Front, Marching Cubes, etc.) can be employed to reconstruct a polygonal mesh (representing the compensated object) from the set of points p_{c}. In some embodiments, a hole filling algorithm can fill holes left by the reconstruction algorithm, potentially resulting in a watertight mesh. In other embodiments, mesh connectivity information is retained at all times during the compensation step 113. In some embodiments, the compensation step may include a method to account for cases in which the surface of the object cannot pass through all points p_{c} and allow the object to remain non-self-intersecting. An example of such a case arises when the set of points pₒ that lie upon faces which meet at a sharp edge are offset inwards such that extraneous points exist beyond the sharp edge. In this example, in lieu of a method to remove the extraneous points, the compensated 3D geometry would include a long triangular profile that would run along the extent of the edge.

In some example embodiments, a support placement planning step 114 is used to plan the placement of support structures. In some example embodiments of block 114, some points pₛ may be assessed to constitute one or more areas which should be supported by support structures. The set of points pₛ could be, for example, a subset of the set of compensated points p_{c} or potentially a subset of the set of uncompensated points pₒ. In some embodiments in which the set of points pₛ is a subset of the set of points pₒ, the inclusion of a point pₒ into the set of points pₛ could preempt the calculations (such as those in blocks 111 and 112) which would result in a deviation prediction for that point p., and the calculation of the point p_{c} implied by the point pₒ. In one embodiment, the compensated object could be based on the union of point sets p_{c} and pₛ. This could, for example, result in the supported areas remaining uncompensated. In some embodiments in which the points pₛ are a subset of the points pₒ, the positions of the loops of line segments which lie on the surface of the object and delimit neighborhoods in which points pₛ exist could be calculated (potentially via one of the methods enumerated in paragraph [0043]). In some embodiments, such “border loops” could be offset (for example, into and/or outwards from the neighborhoods of points pₛ) to create a “border band.” The points p, which lie within the border band could constitute a set of points p_{b}. Each point p_{c} implied by each point pb could be calculated, along with the radial position r of p_{b} within the border band (which could, for example, be the ratio of the distance from p_{b} to the inner boundary of the border band relative to that to the outer boundary). In an example embodiment, a point pᵢ could be calculated to lie between (for example, be colinear with) each pair of points p_{b} and p_{c}. The distance |p_{b}pᵢ| could be calculated by multiplying the distance |p_{b}p_{c}| with f(r), where f is an interpolation function (such as, for example, linear, softmax, etc.). Doing so could, for example, create a smooth transition from the uncompensated supported region to the compensated unsupported region. In one embodiment, the compensated object could be based on union of the point sets p_{c}, pᵢ, and pₛ.

In some embodiments, the criteria by which each point p_{c} or pₒ is evaluated for inclusion in the set of points pₛ may include an evaluation of elements such as the normal vector of the surface upon which p_{c} or pₒ lies, the deviation predicted to be exhibited at p_{c} or pₒ, and the size (evaluated by metrics which could include measurements such as area, dimensions, thickness, etc.) of the neighborhood of contiguous points which satisfy such an evaluation criterion. In one example embodiment, the actual boundary of regions(s) assessed to require support structure(s) may be implied by the area bounded by the smallest loop of consecutive straight lines which lie upon the surface of the object and encompasses a neighborhood of points pₛ, or by other methods, such as by the extent of the contiguous cells which are based upon points pₛ in the Voronoi diagram created from all points p_{c} or pₒ.

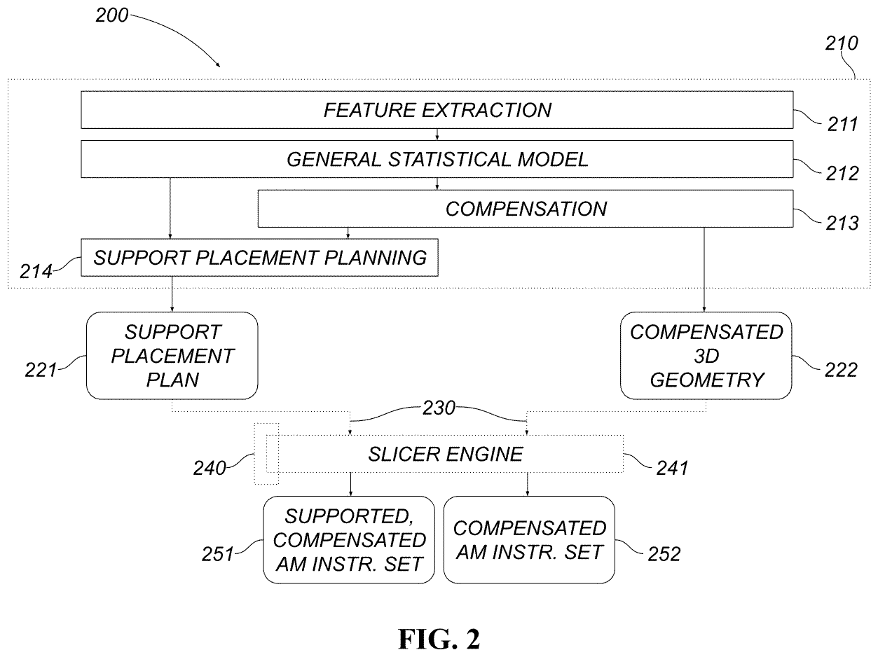

The embodiment of FIG. 1 may be extended as shown in FIG. 2, which shows a flow chart 200 of the computational steps of a method which can produce geometrically compensated 3D objects and/or optimum support placement plans, that can become the input to a slicing step that can produce compensated and/or optimally supported AM instruction sets. In one example embodiment, the compensated 3D geometry 222 produced by the compensation step 213 is received 230 (shown in phantom) by a slicer engine 241 (shown in phantom). In some embodiments, the slicer engine could exist as a standalone component. In some embodiments, it could arise in the context of a slicer application 240 (shown in phantom). The slicer engine 241 may slice objects into 2D sections which represent each layer to be manufactured by the AM device. In some embodiments, every layer of an object is not necessarily of the same height. The 2D sections may then be processed by a variety of algorithms which handle the generation of “walls,” “infill,” and other constructs which commonly constitute AM instruction sets. Some examples of items that do not constitute the object(s) to be manufactured but are nonetheless manufactured concurrently with the payload object(s) include brims, skirts, rafts, wipe towers, draft shields, etc., as well as support structures. The instructions that can cause the AM device to manufacture such non-payload object(s) may be generated by the slicer engine 241 along with the instructions that can cause the manufacturing of the payload object(s). In some embodiments, the user may specify custom modifiers of the instruction set, such as phrases which are to be placed at its start and/or end. The user could (in some embodiments) specify the “flavor” (e.g., Teacup, Smoothie, Machinekit, etc.) of the instructions.

### The Components of the User's Computer

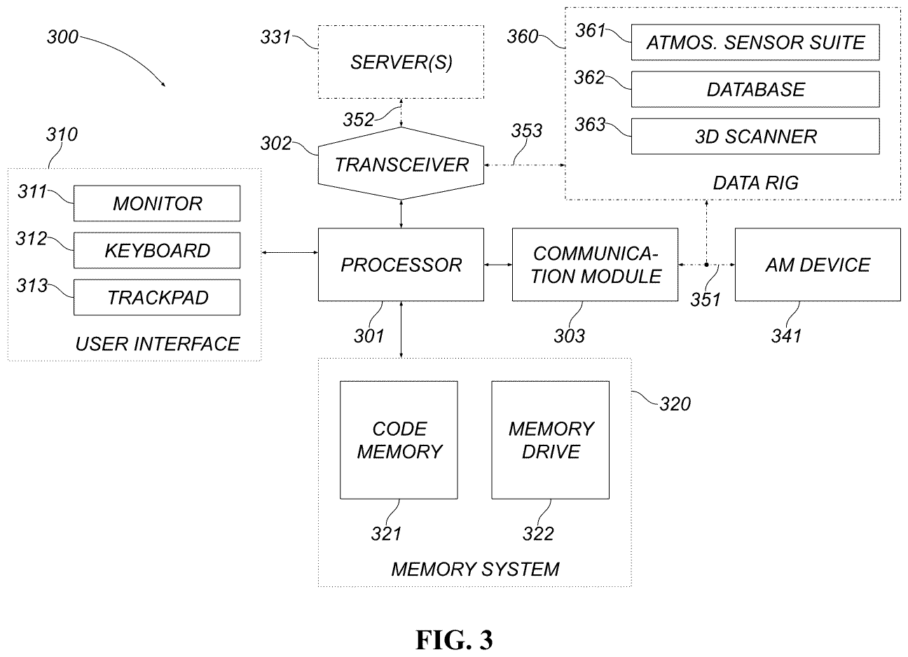

FIG. 3 is an example embodiment of a computer system 300 on which software can be installed. The system may include a user interface 310 (which may include a monitor 311, keyboard 312, trackpad 313, etc.), a memory system 320 that may include a memory drive 322 (i.e., a hard-drive, disk drive, magnetic storage, etc.) in which 3D geometry may be stored and from which it may be accessed by the software, as well as a device 321 which can store code which when executed in a particular programing language (such as, for example, R, Python, C++, etc.) implements the software, and a processor 301 capable of executing such code. The software can implement functionality which may include deviation prediction and compensation calculations, support structure placement planning, and even (in some embodiments) AM instruction set preparation. In some embodiments, the software can also implement a user interface, which could include elements such as graphics and/or text. In some embodiments, the software can even include an entire slicer application.

In an example embodiment, the user's computer on which the software is installed is a computer system 300 consisting also of a communication module 303 which, among other things, could allow it to transmit data (such as AM instruction sets) to the AM device 341. In one example, the transmission 351 may be direct, such as through (for example) a data bus (such as, for example, a USB port) on the user's computer and to the AM device (for example, through a cable), or indirect, such as (for example) through an SD slot on the user's computer, onto an SD card, and to the AM device via another SD slot on the AM device. In some exemplary cases, the computer system 300 also includes a transceiver module 302 which allows it to transmit and receive data 352 (e.g., over the internet, Bluetooth, a leased line, etc.) to and from one or more separate computers (i.e., server(s), such as 331). In addition to means involving cables or the physical movement of data on a memory device such as, for example, an SD card or USB thumb drive, in some embodiments the user's computer may transmit 351 AM instruction sets to the AM device by wireless means, such as, but not limited to, over the internet or a Bluetooth connection, for example using its transceiver module 302. Frequently, the finished instruction set may be stored in a digital file in the user's computer's file system (for example inside of its memory drive 322) for later use. In some embodiments, instructions are transmitted 351 sequentially to the device as they are executed.

### Servers

In some embodiments, some or all the computations (such as those in block 210, those which could be performed by a slicer engine 241, etc.) may be performed remotely from the user's computer 300 (e.g., by one or more server computers 331). The user's computer may, for example, perform the feature extraction 211. It may then, for example, use its transceiver module 302 to transmit 352 (e.g., over the internet, Bluetooth, a leased line, etc.) the results of a computation (e.g., the extracted features from block 211) to, e.g., a server computer(s) 331. The server computer(s) may complete one or more computational steps using the data it receives. For example, the server may apply the feature data 211, to, e.g., a general statical model 212, which may result in a set of predicted deviation values. The server computer(s) 331 may then, in some embodiments, transmit 352 (for example, using its own transceiver module, via some medium, e.g., the internet, Bluetooth, a leased line, etc.) the set of predicted deviations back to the user's computer 300. In some embodiments, the user's computer may use its transceiver module 302 to receive data transmitted from the server computer(s) 331. The user's computer may then perform more computations based on the data it receives from the server computer(s). These computations may result in the production 3D geometry which includes compensation for AM deviations. They could also result in support placement plans, such as support placement planning 214 leading to support placement plan 221. In some embodiments, such as those that include a slicer engine 241, they could even result in the production of an AM instruction set which could include compensation for geometric deviations (252) and/or support structures (251) that are placed only and exactly where necessary.

In another example embodiment, the user's computer 300 could serve solely or primarily as an interface between the user and the one or more server computers 331. The user's computer may, for example, use its transceiver module 302 to transmit 352 a request to one or more sever computers 331. The server computer may, for example, perform a transmission back to the user's computer, which could result in the user's computer displaying a user interface. This user interface may resemble, for example, the interface which could be found in an embodiment without sever computers, or in an embodiment which uses server computers to perform (or aid in performing) computations (such as those in block 210, those performed by a slicer engine 241, etc.) which can result in geometrically optimized 3D objects, optimum support placement plans (251), AM instruction sets that include compensation for AM deviations (252), etc. In some embodiments, the server computer(s) may cause the user's computer to display a user interface and also perform (or aid in performing) such computations.

In some embodiments, the user's computer 300 and the server computer(s) 331 could use their transceiver modules to collaborate, e.g., to complete some or all computations (which may include those shown in block 110). Such collaboration may, for example, occur sequentially (for example, the user's computer may complete some computations, and, in some embodiments, transmit the result to the server computer, which may then complete more computations). The collaboration may also be concurrent (for example, the user's computer may perform computations based on some 3D objects and the server computer may perform computations based on other 3D objects, e.g., simultaneously and, for example, to produce the same output). In some embodiments, collaboration may be concurrent for a single computational step (for example, both the server computer and the user's computer may perform, for instance, feature extraction 211 on the same 3D object, e.g., simultaneously).

In some embodiments, multiple server computers 331 may be employed. In an example embodiment, one server computer may perform some computational steps. Another server computer may then perform more computational steps. The use of the additional server computer(s) may be, for example, intentional (e.g., a specific server computer may be adapted to efficiently perform one computational step, and another server computer may be adapted to efficiently perform a different computational step), or unintentional (e.g., a server computer is unable to complete the computation). In other embodiments, multiple server computers may work concurrently. For example, two or more server computers may perform feature extraction on the same 3D object, e.g., simultaneously. In other embodiments, two or more server computers could perform computations for two or more 3D objects, e.g., simultaneously. In other embodiments, one, two, or more server computers and the user's computer could perform computations, e.g., simultaneously.

### Data Rig

In some embodiments, the computer system 300 may be communicably coupled to elements which can constitute a “data rig” 360, that can, among other things, produce and log data based on AM processes. Such data could potentially include data recorded, for example, before, during, or after the print. Data could include that from an atmospheric sensor suite 361, which could pertain to atmospheric factors such as, for example, temperature, humidity, dew point, air movement, etc. In some embodiments, the data could be recorded at intervals such as, but not limited to, every hour, minute, or second. The data could be logged, for example by the computer system 300 in such a way as to permit the application of a “data pipeline” 920 to the data that the rig produces. The data could be stored in a memory system, which could be embodied as a database 362. The database 362 could be stored on a computer system (such as in the memory drive 322 of the computer system 300 or in a separate computer system). The database could be stored on a dedicated storage hardware, such as (for example) a Redundant Array of Independent Disks (RAID) setup or a Secure Digital (SD) card, which could be used (for example) within a network-attached storage (NAS) system or a direct-attached storage (DAS) system. The database may be managed by software, such as, for example, a database management system (DBMS, examples of which include MySQL, MongoDB, etc.). Data could be accessed by executing code, such as that written in a database query language (examples of which include SQL, ISBL, etc.). In some embodiments, the data stored in the database 362 may include, among other things, none, some or all of that enumerated in paragraph [0038]. In some embodiments, a 3D scanner 363 can produce virtual 3D representations of objects, such as those which may be manufactured by an AM device 341. These virtual representations can be stored in computer readable medium, for example in the database 362.

The data rig 360 (or elements thereof) could be communicably coupled to a computer system 300. This could be achieved by transmissions 351, such as through a communication modal 303 on a computer system 300. The transmission 351 could be, for example, through a wire. In some embodiments, the data rig 360 (or elements thereof) could be communicably coupled to a computer system 300 using a transceiver module 302, which could transmit 353 data, potentially via wireless means (such as over a wireless local area network). Some parts of the data rig may not be physically co-located (such as with other parts of the data rig, or the computer system 300) (that is, some parts may be geographically dispersed), and data transmission may involve third party infrastructure (such as, for example, telephone wires, fiber-optic cables, cellular towers, network cabling, cellular signals and associated infrastructure, wireless signals and associated infrastructure, etc.). In some embodiments, different elements of the data rig 360 are communicatively coupled to the computer system 300 by different means, for example using both the communication module 303 and the transceiver module 302. Elements of the data rig can even be communicably coupled to each other either in a wired or wireless structure. It should be appreciated that the term “data rig” as used herein is meant to be non-limiting and is used for the purposes of describing exemplary embodiments.

### Software

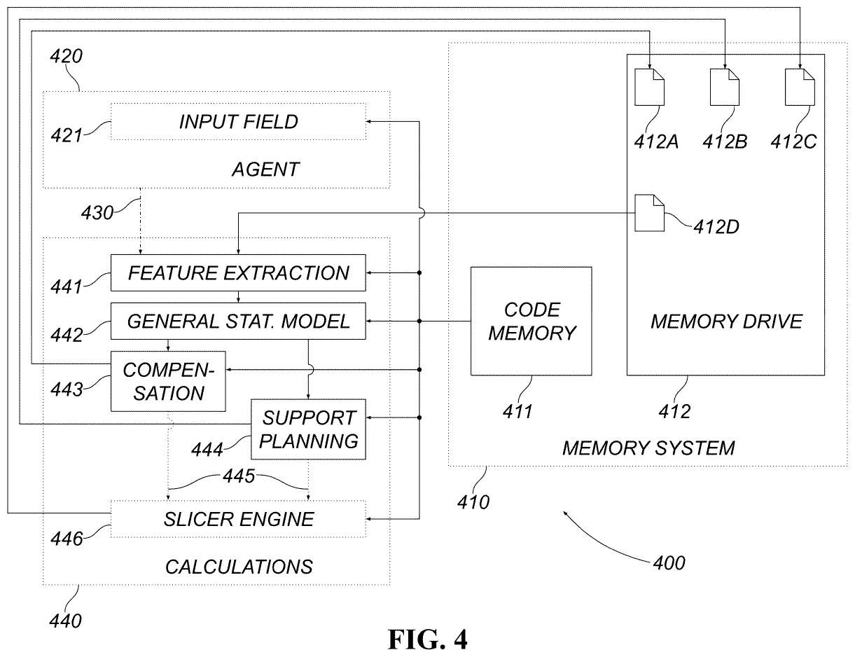

FIG. 4 shows an overview 400 of an exemplary memory system 410 (such as could be found in a computer system 300) as well as an exemplary agent 420 that could invoke 430 a sequence of calculations 440 that can produce optimal support placement plans and 3D geometry that includes compensation for AM deviations. In the overview 400, the computational steps can be extended 445 (shown in phantom) with a slicer engine 446 (shown in phantom), which can result in an AM instruction set that can cause an AM device to manufacture 3D geometry that includes compensation for AM deviations, and even in an AM instruction set that can cause an AM device to manufacture such 3D geometry along with optimally placed support structures.

In one example, code can be loaded from the code memory 411 which, when executed by a processor (not shown in FIG. 4) can create an agent 420. In one embodiment, the agent can optionally include an input field 421 (shown in phantom), such as could be displayed (i.e. to a user). In some embodiments, inputs (for example, to the agent 420 or into the field 421) can invoke 430 a sequence of calculations 440. Inputs could involve data that can inform the nature and output of the calculations. This data may include, among other things, none, some or all of that enumerated in paragraph [0038]. In some embodiments, some or all the data involved in invoking 430 a sequence of calculations 440 could be stored in one or more virtual files 412D. In some embodiments, the calculations could be invoked by providing data directly and/or by referencing files 412D. In one embodiment, the input field 421 is text based. Text that could invoke 430 calculations could be entered (for example, by a user, GUI automation script, etc.) into the field. Text that could invoke 430 calculations could even be stored in a virtual file, for example in the computer's memory drive 412, potentially along with other text. Calculations could even be invoked remotely, such as from another computer or computing device.

In some embodiments, the agent 420 invoking 430 the sequence of calculations 440 can cause code to be loaded from the code memory 411 to be executed on the computer system's processor. In one example, when executed this code can cause a sequence of calculations 440 to occur that may result in the production of an AM instruction set which potently includes compensation for AM deviations. The code can cause features (such as numerical features) to be calculated 441 based on 3D geometry, such as that which could be included when the sequence was invoked. The code can further cause the features to be applied to a general statistical model 442, which can result in predictions of deviation values. In some embodiments, if specified (such as by the user, a configuration datum, etc.) the code can use the predicted deviation values from the model 442 for further computations that can virtually modify the 3D geometry to compensate for AM deviations 443 and/or the produce a support structure placement plan 444. In some cases (for example, always, or if specified, such as when the sequence was invoked), the results these computations can be stored, such as, but not limited to, in virtual files in the computer's memory drive 421. For example, the compensated 3D geometry produced by the compensation step 443 could be stored in a file 412A, and/or the support placement plan produced by the support placement planning step 444 could be stored in a file 412B. In some examples, the code stored in the code storage 411 can, when executed on the computer's processor, further implement a slicer engine 446, which can receive 445 the results of previous computations (such as those in blocks 443 and/or 444) and produce an AM instruction set which can be based on the previous computations. In some embodiments, the AM instruction set may be stored in the memory drive 412, such as in a virtual file 412C. In some embodiments, the AM instruction set can be transmitted (for example, by the computer's transceiver module 302, communication module 303, etc.) to an AM device. AM instructions could even be transmitted sequentially, as they are executed by the AM device. In one embodiment, the AM instruction set can cause an AM device to manufacture the 3D object(s). In one embodiment, the AM instruction set can include compensation for AM deviations, such as that calculated in the compensation step 443. In one embodiment, the AM instruction set can include the instructions that can cause the device to manufacture support structures (which can be placed, in some examples, according to the support placement plan which can be generated by the support placement planning step 444). In one embodiment, the AM instruction set can include other non-payload objects such as, for example, skirts, rafts, wipe towers, draft shields, etc.

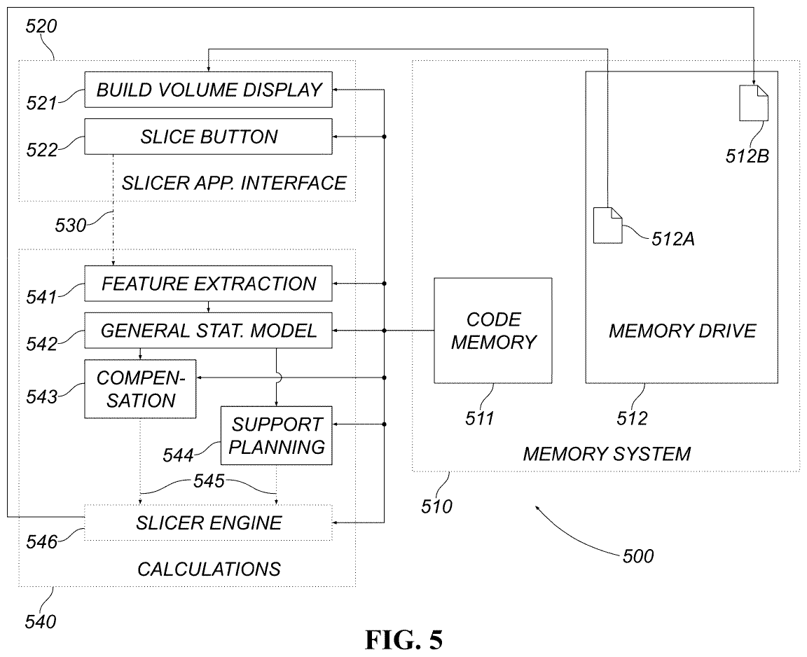

FIG. 5 shows an overview 500 of an exemplary memory system 510 (such as could be found in a computer system 300) as well as a sequence of calculations 540 which can occur in the context of an exemplary slicer application. In one example, the user can open the slicer on their computer and code can be loaded from the computer's code storage device 511 in its memory system 510. The code can be executed by the computer's processor (not shown in FIG. 5), causing an exemplary slicer application interface 520 to be presented. The slicer interface could, among other things, depict elements that may include a representation 521 of the configuration of the volume in which the AM device manufactures 3D objects (and representations of the entities therein, such as but not limited to, the 3D objects themselves) and a “slice button” 522, the latter of which could be used (such as by the user) to initiate 541 the sequence of calculations 540. Using the computer system's user interface components (not shown in FIG. 5), the user can specify 3D geometry, such as that which could be stored in the computer's memory drive 512.

In some embodiments, the user could specify the 3D geometry by selecting one or more virtual files which contain 3D geometry 512A. In some examples, multiple 3D objects could be contained in a single virtual file. A virtual file 512A could even contain other data, which may include, among other things, some or all of that enumerated in paragraph [0038]. In some embodiments, the user interface could include elements (which could be graphical, textual, etc.) which can permit the user to enter, select, edit, etc., data which may include, among other things, some or all of that which is enumerated in paragraph [0038].

In one example, by specifying 3D geometry, one or more 3D objects can be loaded. The objects could even be displayed in the build volume display 521. The user may be able to manipulate the object(s), potentially by interacting with them in the build volume display. In one example, such manipulations may include transformations (e.g., rotations, translations, scaling, etc.), and/or geometry operations such as splitting an object into two parts or joining two objects such that they are printed as one. In one embodiment, at some (such as any) point the user may specify more 3D geometry, which could cause it to be loaded into the slicer application. Multiple objects may be manufactured (i.e. simultaneously or sequentially) with an AM device that is executing an AM instruction set.

At some point, an event (such as a pressing of the slice button 522) could occur which can cause more code from the code memory 511 to be executed on the computer system's processor. In one example, when executed, this code can cause a sequence of calculations 540 to occur that may result in the production of an AM instruction set which potently includes compensation for AM deviations. The code can cause features (such as, for example, numerical features) to be calculated 541 based on 3D geometry. The code can further cause the features to be applied to a general statistical model 542, which can result in predictions of deviation values. In some embodiments, if specified (such as by the user, a configuration datum, etc.) the code can use the predicted deviation values from block 542 for further computations. Further computations can include virtually modifying the 3D geometry to compensate for AM deviations 543 and/or the production of a support placement plan 544. The code can also implement a slicer engine 546, which can receive 545 the results of previous computations (such as those in blocks 543 and/or 544) and produce an AM instruction set which can be based on the previous computations. In some embodiments, the AM instruction set may be stored in the memory drive 512, such as in a virtual file 512B.

In one embodiment, the AM instruction set can cause an AM device to manufacture the 3D object(s) loaded into the slicer application 520 (and potentially depicted in the build volume display 521). In one embodiment, the AM instruction set can include compensation for AM deviations, such as that calculated in the compensation step 543. In one embodiment, the AM instruction set can include the instructions that can cause the device to manufacture support structures (which can be placed, in some examples, according to the support placement plan which can be generated by the support planning calculations 544). In some embodiments, the AM instruction set can include other non-payload objects such as skirts, rafts, wipe towers, draft shields, etc. When executed by the AM device, the instruction set can cause the AM device to accurately manufacture the object(s) loaded into the slicer and, if applicable, with supports placed only and exactly where necessary.

### The Objects, Features, and Predictions

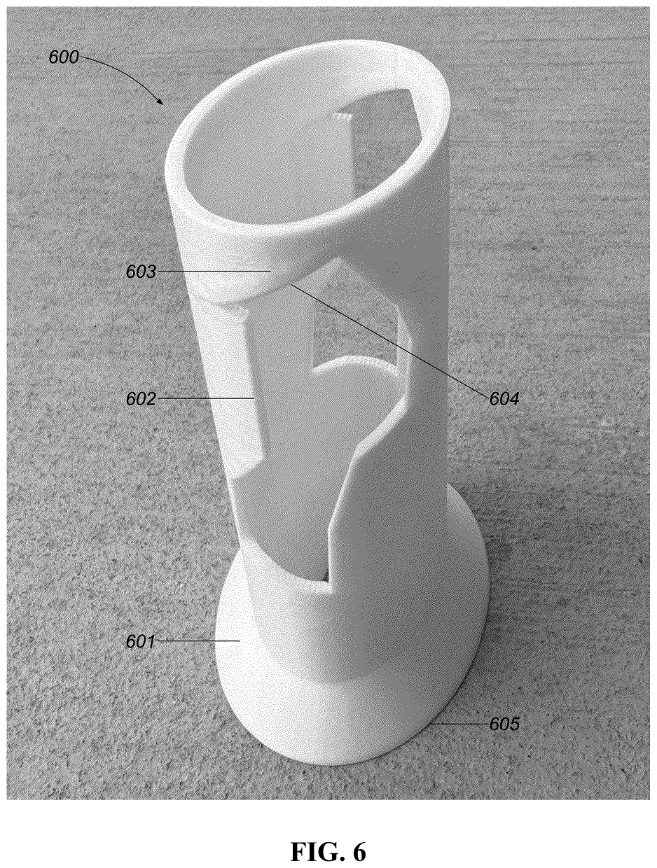

FIG. 6 shows an exemplary object 600 manufactured by an AM device. The object 600 exhibits deviations, such as on its surface 601. Regions which are geometrically salient, intricate, sharp, etc., such as nondifferentiable creases 602 and their surroundings can be especially vulnerable to geometric deviations. Deviations, and structures thereof, can even be visible 603, such as to the unaided eye, which may reduce the athletic merit of an object manufactured by AM technology. Deviation patterns 603 can frequently be caused by physical factors intrinsic to AM processes, such as the physical dynamics (mechanical, vibrational, structural, rheological, etc.) of rapidly tracing a sharp curve with a printhead (such as 1011) of non-negligible mass. Geometry in overhanging regions 604 can frequently, though not necessarily, be manufactured without support structures, especially when deviation compensation is applied. The bottom (“foot”) 605 of the object may be the first part of the object to be manufactured by the AM device, and it may be manufactured directly on the device's build plate.

FIG. 7 shows an exemplary depiction of a set of features 700 which could be extracted from an exemplary 3D object, for example at many point (such as points on the surface of the 3D geometry). In the exemplary depiction 700, the points are colored according to the value of the feature. In some embodiments, geometrically salient regions such as nondifferentiable creases 701 may be reflected in the values of the extracted features. In some embodiments, features for the lowermost section (“foot”) 702 of the object may not be calculated, because the proximity of the “foot” to the build plate (such as 1012) of the AM device could result geometric deviations that may be reflective of deviations patterns exhibited by non-foot regions.

FIG. 8 shows an exemplary depiction of a set of predicted deviation values 800. The deviations can be predicted, for example at many point (such as points on the surface of the 3D geometry). Deviation patterns, such as overfilling caused by overhanging geometry (“slumping”) 801 and erosion caused by the AM device's inability to manufacture very sharp edges 802, can be predicted. Overfilled “ridge” patterns 803 near sharp edges 802 can be predicted, compensation for which could preempt their occurrence 603 in manufactured geometry such as 600. Eliminating those and other deviations can aid the technical and aesthetic viability of objects manufactured by AM processes.

The Development Pipeline (i.e., the Steps by which Trained ML Algorithms are Procured)

In one embodiment, the steps to train a general statistical model such that it is capable of predicting AM deviations include, broadly, a “data rig” capable of producing 3D printed objects (such as 600) and logging them (and potentially data recorded, for example, before, during, or after the print, i.e., from an atmospheric sensor suite) in such a way as to permit the application of a “data pipeline” to the prints the rig produces. In some embodiments, this data may include, among other things, none, some or all of that enumerated in paragraph

In some embodiments the data pipeline may be capable of producing databases to which general statistical models may be fitted.

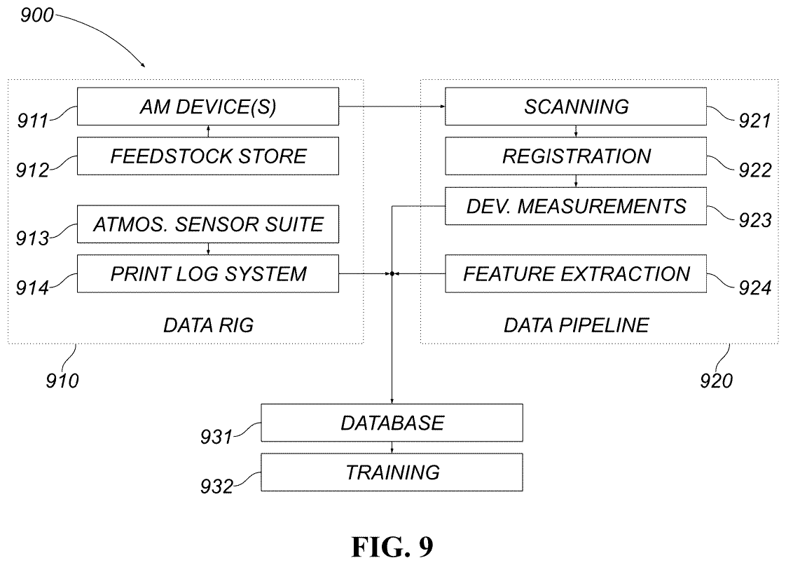

FIG. 9 is an example embodiment of a system 900 by which general statistical models may be fitted to data based on AM processes. In one example, the system 900 can include a data rig 910 consisting of one or more AM device(s) 911 fed with a feedstock store 912. In one example, the AM device(s) 911 and/or the feedstock store 912 may be under the monitoring of an atmospheric sensor suite 913 which can provide atmospheric data, recorded at intervals such as, but not limited to, every hour or every minute, to a print logging system 914. In addition, the print logging system 914 may record data such as the specific AM device and/or batch of feedstock with which each object was printed. In one example, the print logging system 914 may also record items such as the nominal 3D geometry of the objects, the AM instruction set which caused the AM device to manufacture the objects, and/or the slicer settings with which the instruction set was generated. In one example, other recorded metadata can include elements such as, but not limited to, the date and time at which the print was started, the manufacturer of the feedstock used to manufacture the object, whether the feedstock was fed (such as, but not limited to, through a Bowden tube) from a humidity-controlled box, etc. In some embodiments, the data that the print logging system records may further include, among other things, none, some or all of that enumerated in paragraph [0038]. The print logging system can, for example, be implemented as an application on a computer system, and may involve the objects being physically numbered (for example, with a pen, or by being placed into a labeled box or bag) and stored. The print logging system could use a database managements system, such as MongoDB, MySQL, etc.

In one embodiment, the system 900 by which a general statistical model may be trained may include a data pipeline 920. The data pipeline may include a 3D scanning device 921, which may, for example, be a photogrammetry scanner, structured light scanner, MRI scanner, etc. The 3D scanning device 921 may record (such as, for example, into virtual files or with a database management system) the 3D geometry of the as-printed geometry of an object. Such data could be logged by the print logging system 914.

A registration step 922 can align the scanned 3D geometry with the original 3D geometry upon which it is based (which may be provided by the print logging system 914). In some embodiments, this registration step may contain multiple sub-steps. According to one embodiment, the registration step 922 consists of a global registration step followed by a local registration step, followed by a local registration step which only considers the “foot” of the object (i.e., the first to be printed, bottom part of the object). This “footwise” registration step could, for example, align the scanned 3D geometry with the nominal 3D geometry as the physical object would have been aligned relative to the orientation of the nominal geometry implied by the AM instruction set as it was printing in the AM device. This alignment may differ from the alignment provided by the optimum registration of both full 3D geometries. The registration step 922 can, e.g., provide the basis for the measurement of the deviation between the original and scanned 3D geometries at a plurality of points.

According to one example embodiment, the deviation measurement can consist of a step in which many (e.g., 10, 10,000, 1,000,000 or more) points on the surface of the scanned or nominal geometry are selected (for example by a method outlined in paragraph [0030]). At many such points pₒ, a point pₚ can be found on the surface of the other (i.e., the nominal geometry when pₒ lies on the scanned geometry or vice versa) 3D geometry by, for example, calculating the intersection with the other 3D geometry of the ray which originates at p, and projects towards the other geometry along (or diametrically opposite to) the normal vector of the surface upon which pₒ lies. The distance between each pair of points pₒ and pₚ can be associated with the point pₙ which lies upon the nominal geometry and is coincident with pₒ or pₚ, or, if the ray never intersected the original 3D geometry (i.e., the distance is infinite) can be ignored. In some embodiments, the 3D scanning device 921 may not capture the entire surface of the object. Some embodiments could preempt the projection of rays through uncaptured parts of the scanned geometry (and the corresponding erroneous distance measurement) by, for example, placing points pₒ on the scanned geometry such that rays will be projected onto the unbroken surface of the nominal geometry, potentially after ensuring that the nominal geometry is watertight.

A feature extraction step 924 can generate descriptions of the geometry which surrounds each point pₙ. In one example, these descriptions can include the angle between the normal vector of the surface upon which the point pₙ lies and the normal vector of the print bed. In one example, these descriptions can include descriptors such as, for example, Fast Point Feature Histograms (FPFH) and/or Signature of Histograms of Orientations (SHOT), etc. In one example, each point pₙ can be associated with both a deviation measurement from block 923 and a feature set from block 924.

In some embodiments, data based on the “foot” of the object (i.e., the first to be printed, bottom part of the object) may not be logged to the database 931, which could cause the general statical model to not be fitted to data which could be based on regions whose proximity to the build plate may have affected the local deviation values. In some embodiments, data based on the “foot” of the object is not calculated.

In one embodiment, the data from the print logging system 914 (including that from the atmospheric sensor suite 913), as well as the deviation measurements from block 923 and the features extracted in block 924 can be saved to a database 931. The database may contain data from multiple objects manufactured by multiple AM devices. In block 932, the general statistical model can be trained on the data in the database 931. In some embodiments, this training can occur for a set number of epochs or until the model performs to a certain standard, as measured by a metric (such as, but not limited to, mean squared error) known to a person of ordinary skill in the art. The training block 932 can produce a trained general statistical model which can predict AM deviations and, in some embodiments, is ready to be distributed (such as in the software of this disclosure). The system 900 may be used multiple times to produce multiple trained general statical models for multiple AM devices and configurations (such as, for example, permutations of, among other things, none, some or all the elements enumerated in paragraph [0038]) thereof.

Exemplary embodiments of the “data rig” of block 910 (as described in paragraph) [0065]) The data rig may include the system 300 which may include (among other things) an AM device (such as AM device 341) (which, among other things, features a printhead and a build plate) that can manufacture 3D objects, such as object 600, as described above. The AM device can function as an embodiment of block 911. A 3D scanner can produce 3D geometry data (which in some implementations can be stored, for example on a computer system 300, in virtual files, databases, etc.) which is based on physical 3D objects, such as those produced by the AM device. The computer system 300, can, among other things, support a print logging system 914 which can log data (which can include, among other things, none, some or all the elements enumerated in paragraph [0038]) pertaining to factors such as, for example, the configuration, usage, etc., of the AM device. The data can be logged to a database 931, which could be hosted on the computer system 300. The computer system can further execute computational steps such as registration 922, deviation measurement 923, and feature extraction 924, the results of which could be logged to the database 931 and could be used (such as by the computer system) in the training 932 of general statistical models. The AM device can be supported by a feedstock store.

In another exemplary data rig of block 910, an AM device (such as AM device 341) can manufacture 3D objects, such as could be scanned with a 3D scanner. A print logging system 914 could involve physically labeling manufactured 3D objects (or containers thereof), such as, for example, with a writing utensil. The print logging system 914 could be implemented as an application of a computer system 300 and could even feature a graphical user interface (GUI). The computer system 300 could receive atmospheric data from an atmospheric sensor suite and, for example, store it in a database 931. The atmospheric sensor suite could function as an embodiment of block 913.

The foregoing describes the various embodiments in exemplary configurations; however, it should be appreciated that the various components may be configured in a variety of ways. Further, it should be appreciated that the components of the various embodiments may be combined into one or more devices, collocated on a particular node of a distributed network, or distributed at various locations in a network, including being geographically separated, for example. As will be appreciated by those skilled in the art, the components of the various embodiments may be arranged at any location or locations within a distributed network without affecting the operation of the respective system.

As described above, the various embodiments support a number of devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, application, or software.

The foregoing examples show the various embodiments in one physical configuration; however, it is to be appreciated that the various components may be located at distant portions of a distributed network, such as, for example, a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object-oriented programming. The software tells the processor what to do with the data being processed.

Further, it is appreciated that the instructions or set of instructions used in the implementation and operation the various embodiments may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments. For example, the programming language used may include assembly language, Ada, APL, Basic, C, C++, COBOL, dBase, Forth, Fortran, Java, Modula-2, Pascal, Prolog, Racket, REXX, Visual Basic, and/or JavaScript. Further, it is not necessary that a single type of instructions or single programming language be utilized in conjunction with the operation of the system and method of the various embodiments. Rather, any number of different programming languages may be utilized as is necessary or desirable.

Also, the instructions and/or data used in the practice of various embodiments may utilize any compression or encryption technique or algorithm, as may be desired. An encryption module might be used to encrypt data. Further, files or other data may be decrypted using a suitable decryption module, for example.

In the system and method of exemplary embodiments, a variety of user interfaces (including graphical user interfaces or GUIs) may be utilized to allow a user to interface the systems described in the various embodiments. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as, for example, Software-as-a-Service (Saas), Platform-as-a-Service (PaaS), and Infrastructure-as-a-Service (IaaS), and/or using one or more deployment models such as, for example, public cloud, private cloud, hybrid cloud, and/or community cloud models.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A method, performed by a computer system comprising one or more processors and a memory system comprising computer memory containing non-transitory instructions, for providing deviation prediction, compensation, and support placement optimization for additive manufacturing (AM) processes, comprising:
receiving 3D geometry of one or more shapes to be printed;
selecting a plurality of points on a surface of the 3D geometry;
calculating numerical descriptions of the 3D geometry surrounding each of the plurality of points;
predicting a deviation at each of the plurality of points by comparing the calculated numerical descriptions with numerical descriptions associated with measured deviations in historical prints;
and at least one of:
compensating for deviation by offsetting the geometries such that an as-printed shape will match the received 3D geometry; or
selecting regions to be supported based on the predicted deviation, normal vectors of the surfaces for which the deviation was predicted, and dimensions of the regions so selected, wherein offsetting the geometries consists of applying an equivalent amount of offset based on the predicted deviation.

2. The method of claim 1, wherein calculating numerical descriptions of the 3D geometry comprises calculation of numerical descriptors, that are applied to a general statistical model.

3. The method of claim 1, wherein calculating numerical descriptions of the 3D geometry comprises the calculation of an angle between a normal of the surface on which a point lies and a normal of a print bed, that is applied to a general statistical model.

4. The method of claim 1, wherein predicting the deviation is based on applying the calculated numerical descriptions to a general statistical model.

5. The method of claim 4, wherein the general statistical model comprises: a machine learning (ML) algorithm, fitted to numerical descriptions and measured deviations of historical prints, that is applied to the calculated numerical descriptions of the 3D geometry.

6. The method of claim 1, wherein offsetting the geometries comprises applying an equivalent amount of offset based on the predicted deviation.

7. The method of claim 6, wherein the equivalent amount of offset consists of offsetting a local geometry an equal amount in an opposite direction of the predicted deviation.

8. The method of claim 1, wherein one or more of the method steps are performed on one or more remote server computers communicatively coupled to a user's computer.

9. A system, for providing deviation prediction, compensation, and support placement optimization for additive manufacturing (AM) processes, comprising:
one or more computer servers comprising one or more processors;
non-transitory computer memory comprising instructions, that, when executed by the one or more processors, cause the one or more processors to:
receive 3D geometry of one or more shapes to be printed;
select a plurality of points on a surface of the 3D geometry;
calculate numerical descriptions of the 3D geometry surrounding each of the plurality of points;
predict a deviation at each of the plurality of points by comparing the calculated numerical descriptions with numerical descriptions associated with measured deviations in historical prints;
and at least one of:
compensate for deviation by offsetting the geometries such that an as-printed shape will match the received 3D geometry; or
selecting regions to be supported based on the predicted deviation, normal vectors of the surfaces for which the deviation was predicted, and dimensions of the regions so selected, wherein offsetting the geometries consists of applying an equivalent amount of offset based on the predicted deviation.

10. The system of claim 9, wherein calculating numerical descriptions of the 3D geometry comprises calculation of numerical descriptors that are applied to a general statistical model.

11. The system of claim 9, wherein calculating numerical descriptions of the 3D geometry comprises the calculation of an angle between a normal of the surface on which a point lies and a normal of a print bed, that is applied to a general statistical model.

12. The system of claim 9, wherein predicting the deviation is based on applying the calculated numerical descriptions to a general statistical model.

13. The system of claim 12, wherein the general statistical model comprises: a machine learning (ML) algorithm, fitted to numerical descriptions and measured deviations of historical prints, that is applied to the calculated numerical descriptions of the received 3D geometry.

14. The system of claim 9, wherein offsetting the geometries comprises applying an equivalent amount of offset based on the predicted deviation.

15. The system of claim 14, wherein the equivalent amount of offset consists of offsetting a local geometry an equal amount in an opposite direction of the predicted deviation.

16. The system of claim 9, wherein the one or more computer servers are communicatively coupled to a user's computer.

17. A non-transitory computer-readable medium comprising instructions for execution by one or more processors, wherein, upon execution of the instructions, the one or more processors being configured to perform procedures comprising:
receiving 3D geometry of one or more shapes to be printed;
selecting a plurality of points on a surface of the 3D geometry;
calculating numerical descriptions of the 3D geometry surrounding each of the plurality of points;
predicting a deviation at each of the plurality of points by comparing the calculated numerical descriptions with numerical descriptions associated with measured deviations in historical prints;
and at least one of:
compensating for deviation by offsetting the geometries such that an as-printed shape will match the received 3D geometry; or
selecting regions to be supported based on the predicted deviation, normal vectors of the surfaces for which the deviation was predicted, and dimensions of the regions so selected, wherein offsetting the geometries consists of applying an equivalent amount of offset based on the predicted deviation.

18. The non-transitory computer-readable medium of claim 17, wherein calculating numerical descriptions of the 3D geometry comprises calculation of numerical descriptors that are applied to a general statistical model.

19. The non-transitory computer-readable medium of claim 17, wherein calculating numerical descriptions of the 3D geometry comprises the calculation of an angle between a normal of the surface on which a point lies and a normal of a print bed, that is applied to a general statistical model.

20. The non-transitory computer-readable medium of claim 17, wherein predicting the deviation is based on applying the calculated numerical descriptions to a machine learning (ML) algorithm, fitted to data based on previously manufactured objects.
